(19) United States
(12) Patent Application Publication
(10) Pub. No.: US 2019/0321869 A1
(43) Pub. Date: Oct. 24, 2019

(54) METHODS, APPARATUS, AND ASSEMBLY FOR CLEANING GLASS SHEETS

(71) Applicant: CORNING INCORPORATED, CORNING, NY (US)

(72) Inventors: Hsueh-Hung Fu, Hsinchu (TW); Jun Yuan Hou, Tainan City (TW); Shin-I Huang, Taichung City (TW); Sheng-Hung Liu, Kaohsiung-si (TW); Yuyin Tang, Kaohsiung city (TW); Yu-Ting Weng, Tainan City (TW)

(73) Assignee: CORNING INCORPORATED, CORNING, NY (US)

(21) Appl. No.: 16/348,210

(22) PCT Filed: Nov. 8, 2017
(86) PCT No.: PCT/US17/60548

§ 371 Date: May 8, 2019

Related U.S. Application Data
(60) Provisional application No. 62/418,830, filed on Nov. 8, 2016.

(51) Int. Cl. B08B 11/04; B08B 1/00; B08B 1/04; B24B 27/033; B24B 9/10; A46B 13/00; A46D 1/00

(52) U.S. Cl. CPC B08B 11/04; B08B 1/002; B08B 1/04; B24B 27/033; C03C 23/0075; A46B 13/001; A46B 13/008; A46D 1/0207; A46B 2200/3093; B24B 9/10

(57) ABSTRACT

An apparatus for cleaning a glass sheet is provided. The apparatus includes a brushing device including a head and a plurality of bristles, each bristle having a first end attached to the head and a second end opposing the first end. The second ends contact an edge of the glass sheet during cleaning of the glass sheet. Methods for cleaning glass sheets are also provided.

This application claims the benefit of priority under 35 U.S.C. § 119 of U.S. Provisional Application Ser. No. 62/418,830 filed on Nov. 8, 2016 the content of which is relied upon and incorporated herein by reference in its entirety.

### BACKGROUND

The disclosure relates to manufacturing of glass sheets, and more particularly to methods and apparatus for cleaning glass sheets.

Nowadays, glass substrates (e.g., glass sheets or glass plates) are being applied to many high-tech devices, such as display panels for television, computer displays, displays for handheld devices and mobile phones. Manufacturers of those devices are demanding higher quality glasses to enable exhibiting better resolutions. It is found that one of the problems affecting the quality of the glasses is the “particle count” (the number of particles) on the glass surfaces.

Undesired particles may originate from surrounding contaminations, or even be generated during manufacturing processes of glass sheets, for example, scoring (or cutting) the glass sheets into the desired size, edge grinding and/or polishing. Subsequent processes, such as washing of the glass sheets, are adopted to remove particles from the surfaces of the glass sheets. However, known approaches cannot seem to easily lower the particle count to an acceptable quality, or they sometimes require expensive equipment or repetitive processes to remove particles away from the surfaces of the glass sheets. It is known that the residual particles on a glass sheet will form a so-called “particle mist,” which is a thin layer of small particles not only on the two major surfaces but also on the edges of the glass sheet, i.e., the joining surfaces between the two major surfaces (top and bottom surfaces) of the glass sheet.

It has been found that the particle mist tends to migrate during shipping of the glass sheet. Therefore, even though the two major surfaces of the glass sheets have been cleaned, the particle mist from the edges of the glass sheets will still contaminate the major surfaces during shipping. Further, during manufacturing of the glass sheets, the particle count of the major surfaces also has a strong correlation with the particle count of the edge surfaces. According to some experiments, if the particles on the edges of a glass sheet are lower, the particle density on the major surfaces of the glass sheet will decrease as well.

In view of at least the above, there is a need for the developments of edge cleaning of a glass sheet, so as to improve the quality of the glass sheets without raising a huge amount of cost for the manufacturing processes.

### SUMMARY

An apparatus for cleaning a glass sheet is provided, comprising a brushing device including a head and a plurality of bristles extending from the head, at least one bristle of the plurality of bristles containing an abrasive material and including a first end attached to the head and a second end opposing the first end. The abrasive material may comprise Al₂O₃ or SiC or a combination thereof.

The apparatus further comprises a motor coupled to the head to rotate the head about a center axis of the head, and wherein at least a portion of the second ends contact an edge of the glass sheet during cleaning of the glass sheet. In some embodiments, the head may be detachably coupled to the motor.

In some embodiments, the plurality of bristles may extend from the head in parallel with each other and in a direction substantially the same as the center axis of the head. For example, the plurality of bristles may be arranged in a circular pattern defined by a maximum diameter, and wherein the maximum diameter is greater than a thickness of the glass sheet. A baffle may be positioned adjacent the plurality of bristles.

In some embodiments, the motor is coupled to the head by a shaft and the center axis of the head is parallel with a longitudinal axis of the shaft. The motor may impart a reciprocal motion to the head about the longitudinal axis of the shaft

In other embodiments, the motor is coupled to the head by a shaft and the center axis of the head is orthogonal to a longitudinal axis of the shaft.

In some embodiments, the plurality of bristles may extend radially from the head and orthogonal to the center axis.

The apparatus may further comprise a coolant delivering device to direct a coolant toward the second ends of the plurality of bristles. The apparatus may further comprise a spraying device to direct a jet of particle removal fluid toward the edge of the glass sheet.

In some embodiments, a method for cleaning a glass sheet is described, comprising: producing relative motion between an edge of the glass sheet and a brushing device comprising a head including a center axis and a plurality of bristles extending from the head, at least one bristle of the plurality of bristles containing an abrasive material and including a first end attached to the head and a second end opposing the first end. The method may further comprise rotating the head about the center axis and contacting the edge of the glass sheet with the bristles during the rotating. In some embodiments, a rotation speed of the head can be in a range from about 3600 revolutions per minute to about 10,000 revolutions per minute. At least a portion of the plurality of bristles are disposed with the second ends extending a distance beyond the edge of the glass sheet of about 1.5-2.5 mm.

In some embodiments, the method may further comprise directing a coolant toward the second ends of the plurality of bristles.

In some embodiments, producing relative motion between an edge of the glass sheet and a brushing device may comprise moving the glass sheet in a conveyance direction and wherein the coolant is directed in a direction opposite the conveyance direction

The method may further comprise directing a particle removing fluid toward the edge of the glass sheet.

In some embodiments, the method may comprise imparting a reciprocal motion to the head such that the center axis describes an arc in a plane parallel with a major surface of the glass sheet.

In some embodiments, the center axis is parallel with the edge.

Additional features and advantages will be set forth in the detailed description which follows, and in part will be readily apparent to those skilled in the art from that description or recognized by practicing the embodiments as described herein, including the detailed description which follows, the claims, as well as the appended drawing.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is a schematic top view of a glass sheet undergoing different processes, while FIG. 1B is a schematic side view and FIG. 1C is a schematic perspective view of such glass sheet;

FIG. 2A is a schematic perspective view of an exemplary edge cleaning apparatus according to some embodiments of the present disclosure; and FIGS. 2B and 2C are side views of the glass sheet under cleaning;

FIGS. 3 and 4 are schematic perspective views of exemplary edge cleaning apparatus according to alternative embodiments of the present disclosure;

FIG. 5A is a schematic top view of an exemplary edge cleaning apparatus according to some embodiments of the present disclosure;

FIG. 5B is a schematic perspective view of another exemplary edge cleaning apparatus according to some embodiments of the present disclosure;

FIG. 6 is a flow diagram of an exemplary manufacturing process of a glass sheet according to some embodiments of the present disclosure; and

FIGS. 7A and 7B are diagrams showing the quality improvements of glass sheets after subjecting the glass sheets to the cleaning method of the present disclosure.

### DETAILED DESCRIPTION

Reference will now be made in detail to the present preferred embodiment(s), examples of which is/are illustrated in the accompanying drawings. Whenever possible, the same reference numerals will be used throughout the drawings to refer to the same or like parts.

The following provides a description regarding the glass sheets under processing (more specifically, cleaning) by the apparatus and/or methods of the present disclosure.

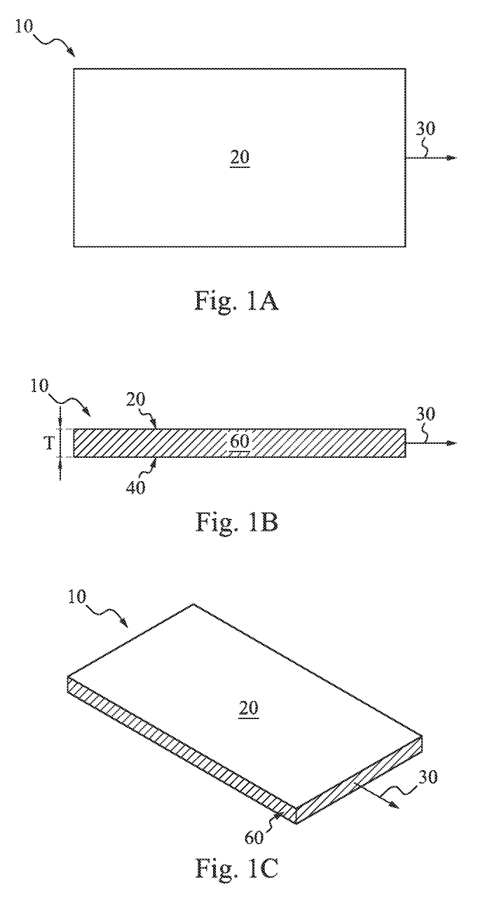

FIGS. 1A-1C are schematic views of a glass sheet 10 as described herein. The glass sheet 10 comprises a first major surface (e.g., a top surface 20), a second major surface (e.g., a bottom surface 40) substantially parallel with the top surface 20, and an edge 60 joining the top and bottom surfaces 20, 40. The distance between the top and bottom surfaces 20, 40, which is also the height of the edge 60, defines the thickness T of the glass sheet 10. During manufacturing processes, the glass sheet 10 may be conveyed in a direction 30. Although edge surface 60 is shown as a planar surface in FIGS. 1A-1C, it should be noted that the edge surface 60 may in further embodiments comprise other shapes. For example, in some embodiments, edge surface 60 may comprise a chamfered surface or a rounded surface, for example as a result of a grinding and/or polishing operation.

As used herein, the terms “top” and “bottom” are determined according to the orientation of the placement of the glass sheet as shown in the figures. It should be appreciated that the glass sheet can be placed in different orientations, and the conveyance direction may vary based on the configurations of different processes. Further, although the embodiments described herein are directed to a glass sheet with rectangular shape, it should be appreciated that the glass sheet may be formed in many different shapes.

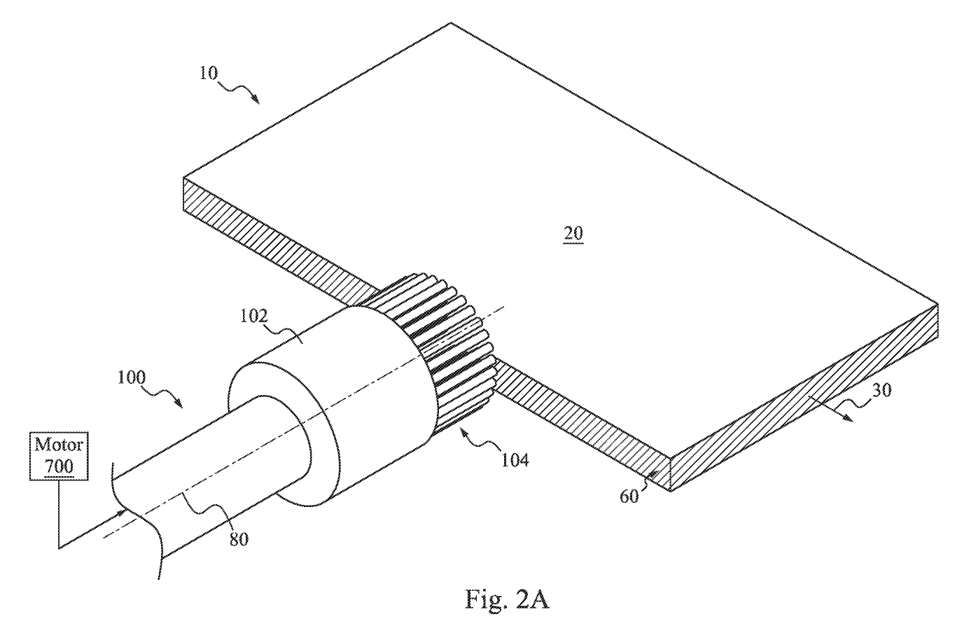

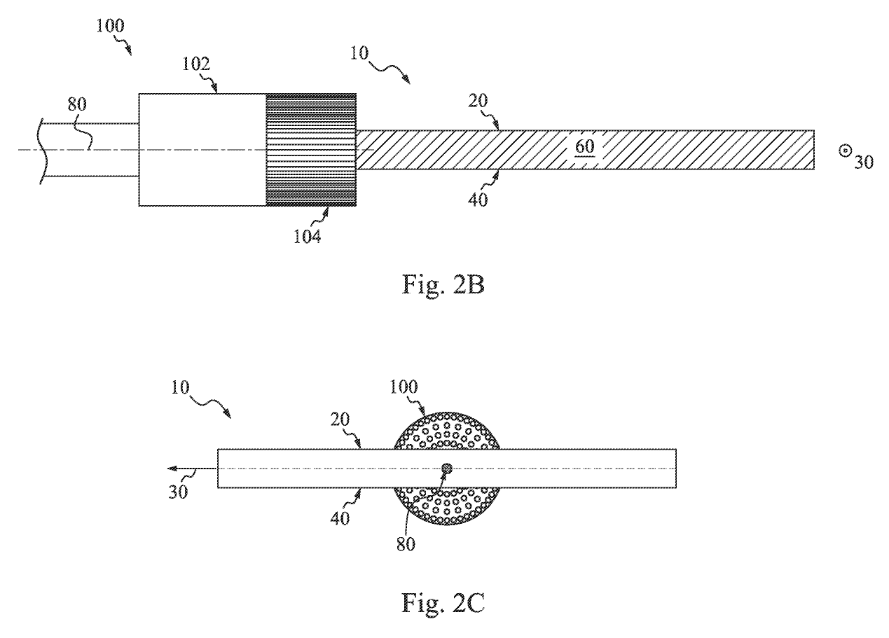

FIGS. 2A-2C are schematic views of an exemplary edge cleaning apparatus according to some embodiments of the present disclosure. With reference to FIG. 2A, the edge cleaning apparatus includes a brushing device 100 comprising a head 102 and a plurality of bristles 104 extending therefrom.

The plurality of bristles 104 are attached to the head 102 at one end and extend in substantially the same direction towards the edge 60 of the glass sheet 10 to be cleaned. As shown in FIGS. 2A-2C, the bristles 104 may be grouped into bundles and retained in holes formed on the head 102. Further, the bristles 104 may extend in parallel with each other and in a direction substantially the same as the center axis 80 of the head 102. The length of the bristles 104 is designed such that the bristles 104 may substantially maintain their original configurations so as to uniformly contact the edge 60 of the glass sheet 10 during the cleaning process. In FIGS. 2A-2C, the bristles 104 have substantially an identical length. However, it should be appreciated that the bristles 104 may have different lengths, for example, with longer or shorter bristles 104 disposed around the circumferences of the head 102, if it is so desired.

The bristles 104 may be made of nylon or any other natural or synthetic materials suitable for brushing or cleaning purposes. In embodiments, the bristles 104 may contain an abrasive material, for example aluminum oxide (Al₂O₃) and/or silicon carbide (SiC), to increase efficiency of cleaning and the durability of the bristles 104. It should be appreciated that other abrasive materials are contemplated.

The head 102 may be coupled to a motor 700 to rotate the head 102 about center axis 80 of the head 102. Prior to cleaning, the brushing device 100 may be positioned aside the edge 60 of the glass sheet 10 and tips of at least some bristles 104 touch the edge 60. As shown in FIGS. 2B and 2C, the head 102 may be positioned such that the center axis 80 is substantially parallel with the top and bottom surfaces 20, 40 of the glass sheet 10 so that tips of the bristles 104 evenly contact the edge 60.

Next, the head 102 is pushed forward by a short distance to move closer to the edge 60, such that at least some bristles 104 extend beyond the edge 60 of the glass sheet 10, overlapping a portion of the top and bottom surfaces 20, 40. As such, particles, debris, or other residues hidden in any cavities of the edges 60 may be removed during cleaning. In some embodiments, the short distance of the bristles 104 being pushed beyond the edge 60 is no more than about 3 millimeters (mm), to ensure the edge 60 of the glass sheet 10 is not overly scrubbed and scratched. In some embodiments, such short distance is in a range of about 1.5 to about 2.5 mm.

In FIGS. 2A-2C, the head 102 is rotated about the center axis 80, such that tips of the bristles 104 in turns contact and sweep over the edge 60 of the glass sheet 10 in a rotational motion. Meanwhile, the glass sheet 10 may be conveyed in the direction 30 in the similar manner to the other manufacturing processes. It should be appreciated that although FIGS. 2A-2C show that the glass sheet 10 is conveyed in the direction 30, the relative movements of between the brushing device 100 and the glass sheet 10 via movement of the head 102 or both of the head 102 and the glass sheet 10 are also contemplated, as desired.

In some embodiments, a region encompassed by tips of the plurality of bristles 104 is slightly greater than the thickness T of the glass sheet 10. Further, prior to cleaning, the center axis 80 of the head 102 may be aligned with a mid-plane bisecting of the edge 60 along a direction parallel with the top and bottom surfaces 20, 40, such that the edge 60 is fully covered by the bristles 104. As such, once the glass sheet 10 moves in relation to the edge cleaning apparatus 100, by moving one of the glass sheet 10 or the brushing device 100, or by moving both, the edges 60 of the glass sheet 10 may be cleaned in one run without movement in other direction. However, multiple runs may certainly be adopted if the bristles 104 are designed such that they do not fully cover the edge 60. It should also be appreciated that although the head 102 is shown with a circular shape, other shapes, such as a rectangular shape or an elliptical shape etc., are also contemplated.

As previously mentioned, the head 102 of the brushing device 100 may be driven by the motor 700 (FIG. 2A) to rotate about the center axis 80 during cleaning of the glass sheet 10. Both rotation directions in clockwise or counterclockwise are contemplated. The speed of rotation is controlled such that the circumference bristles 104 are able to contact the edge 60 of the glass sheet 10 during cleaning. In embodiments, the rotational speed of the head may be at least about 3600 revolutions per minute (rpm) to efficiently remove the particles, debris, or other residuals from the edge 60. In some embodiments, the rotational speed of the head may be up to about 7200 rpm or even up to about 10000 rpm depending on the diameter of the head 102.

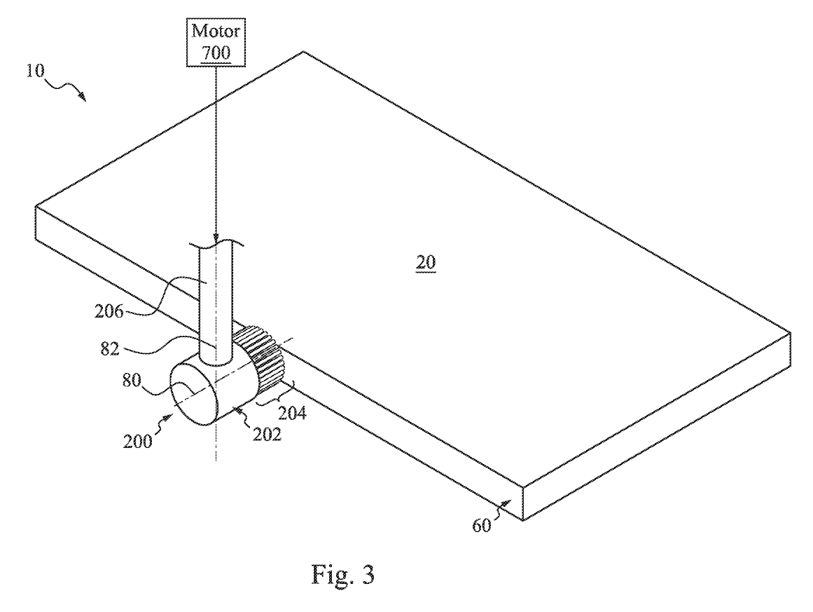

In some embodiments, the motor 700 may also be water-proofed to prevent moisture damage. For example, in some embodiments, a housing may be further provided to partially or completely enclose the motor 700. In some embodiments, the motor 700 may be directly connected to the head 102 of the brushing device 100. In other embodiments, the motor 700 may be operably connected to the head 102 via a shaft, such that the brushing device 100 may be removed or replaced easily. FIG. 3 thus shows a schematic perspective view of another exemplary brushing device 200 according to some embodiments of the present disclosure, in which the brushing device 200 comprises a head 202, a plurality of bristles 204, and a shaft 206 connected to the head 202.

Similar to the brushing device 100 as described with reference to FIGS. 2A-2C, the head 202 faces and aligns with the edge 60 of the glass sheet 10. The head 202 may be coupled to a motor 700 via the shaft 206 to reciprocally rotate about a center axis 82 of the shaft 206, so that the bristles 204 clean the edge 60 in a manner of oscillation motion once the motor 700 drives the shaft 206 to rotate or vibrate. That is, as the head 202 rotates about axis 80, the head may also simultaneously reciprocally rotate about axis 82. In some embodiments, the back and forth oscillation of the head 202 may be up to and including about 7200 times per minute to efficiently remove the particles, debris, or other residuals from the edge 60. Although the head 202 as depicted in FIG. 3 has a substantially circular disk shape, it should be appreciated that the head 202 may have other shapes. Again, the region encompassed by tips of the bristles 204 is preferably large enough to cover the entire thickness T of the glass sheet 10 during the cleaning process.

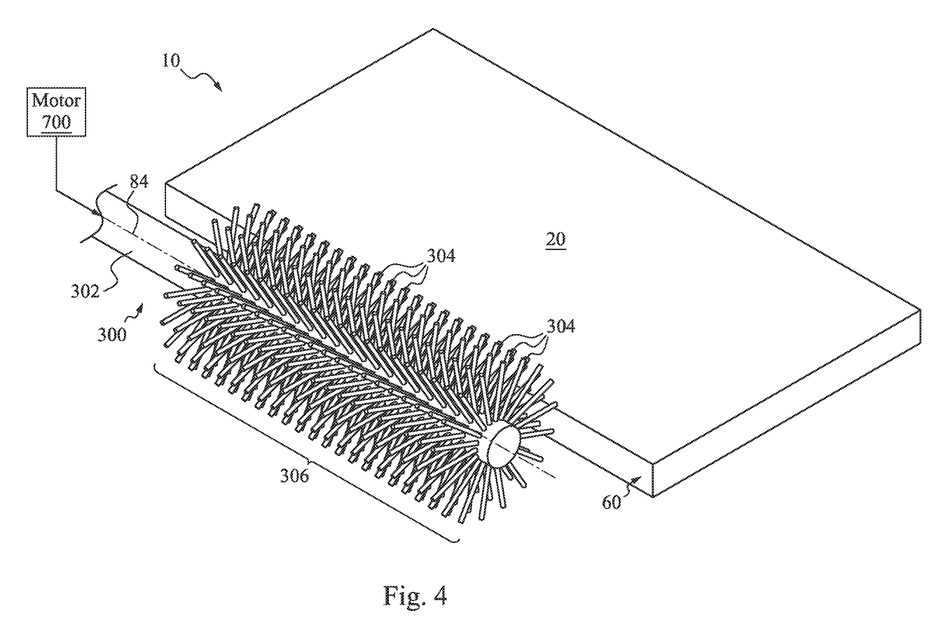

FIG. 4 shows a schematic perspective view of yet another exemplary edge cleaning apparatus according to embodiments of the present disclosure. In FIG. 4, the edge cleaning apparatus comprises a brushing device 300 including a shaft 302 and a head 306, which head 306 can be coupled to shaft 302, although in further embodiments, head 306 may be an extension of shaft 302. A plurality of bristles 304 attach to and radially extend from at least a portion of the shaft 302 (i.e. the head 306). Prior to cleaning, the brushing device 300 is positioned such that a center axis 84 of the shaft 302 and head 306 is substantially parallel with the edge 60 of the glass sheet 10, and at such a distance from the edge 60 that tips of the bristles 304 contact the edge 60, or extend slightly beyond the edge 60.

The brushing device 300 may rotate about the center axis 84 in clockwise or counter-clockwise directions. Since the axis 84 is parallel with the edge 60, the bristles 304 may sweep over either one of the top or bottom surface 20, 40 during a single direction of rotation. Therefore, in order to obtain uniform cleaning effects of the edge 60 of the glass sheet 10, the brushing device 300 may reciprocally revolve (e.g., as in an orbit) about the center axis 84.

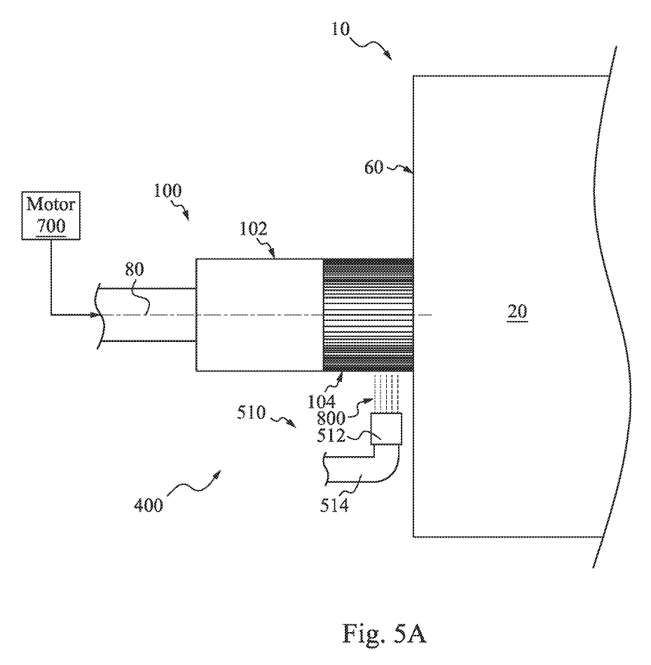

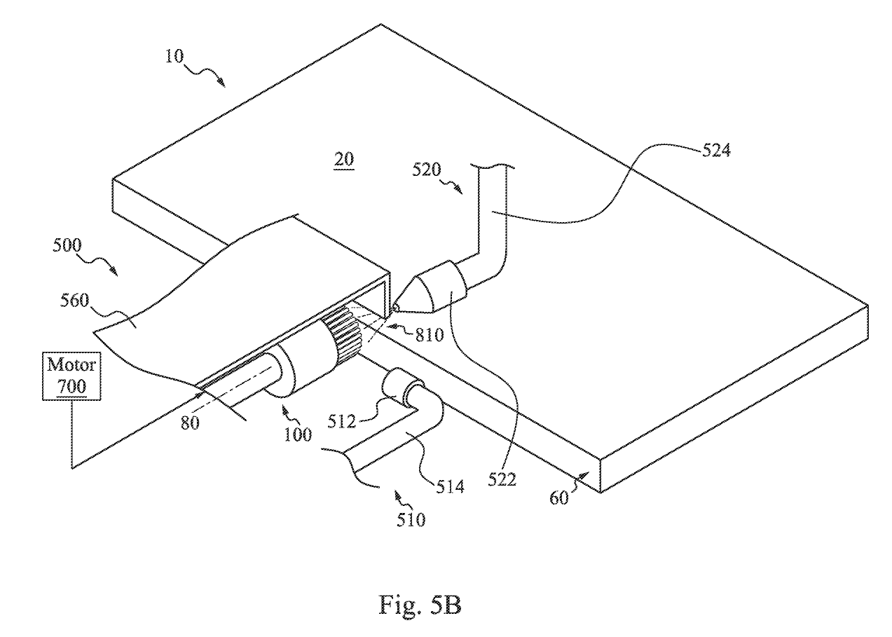

As previously described in the preceding embodiments, continuing contacts are formed between tips of the bristles 104, 204, 304 and the edge 60 of the glass sheet 10 during cleaning, and thus generate frictional heat that may damage the glass sheet 10 or detrimentally affect the lifespan of the bristles 104, 204, 304. FIG. 5A thus depicts an exemplary edge cleaning assembly 400 according to some embodiments of the present disclosure, by modifying the configuration shown in FIGS. 2A to 2C. As shown in FIG. 5A, an optional coolant delivering device 510 is located adjacent to the brushing device 100. The coolant delivering device 510 comprises a tube 514 connecting to a coolant source (not shown) and an outlet 512 for dispensing a coolant 800 towards tips of the bristles 104. Therefore, the coolant delivering device 510 may help removing the frictional heat from tips of the bristles 104.

In embodiments, the coolant 800 dispensed by the coolant delivering device 510 can be water, although it should be appreciated that other types of coolant are also contemplated, as desired. The outlet 512 of the coolant delivering device 510 may be angled to face tips of the bristles 104 and dispense the coolant flow in a direction opposing the conveyance direction of the glass sheet 10. As such, besides heat dissipation, the coolant delivering device 510 may also facilitate removing particles or debris away from the edge 60 of the glass sheet 10. In some embodiments, the angle between the surface of the edge 60 and the outlet 512 may be in a range of about 20 degrees to about 25 degrees to provide sufficient removal force but without resulting in repelling splashes.

FIG. 5B is a schematic perspective view of an exemplary edge cleaning assembly 500 according to some embodiments of the present disclosure. In this figure, the assembly 500 further comprises an optional spraying device 520 and an optional baffle 560. The spraying device 520 comprises a tube 524 for delivering particle removing fluid 810 and a nozzle 522 for dispensing the fluid 810 toward the edge 60 of the glass sheet 10. The nozzle 522 may form a jet facilitating removal of the particles, debris, and/or coolant away from the edge 60. In some embodiments, the nozzle 522 may be positioned to face the edge cleaning apparatus 100 and has an angle between the nozzle 522 and the center axis 80 in a range of about 45 degrees to about 50 degrees to mitigate repellant splashes, if any.

As shown in FIG. 5B, the baffle 560 may be located near an upper portion of the bristles 104, thereby preventing undesired objects, namely the jet, coolant, and/or the removed particles/debris from being repelled back to the surfaces 20, 40 of the glass sheet 10. The baffle 560 may have any shape capable of directing the jet, coolant, and/or the unwanted particles/debris away from the surfaces 20, 40 of the glass sheet 10.

It is apparent that the alternative modifications in FIGS. 5A and 5B may also be implemented in other edge cleaning apparatuses within the scope of the present disclosure, such as the brushing devices 200, 300 described above.

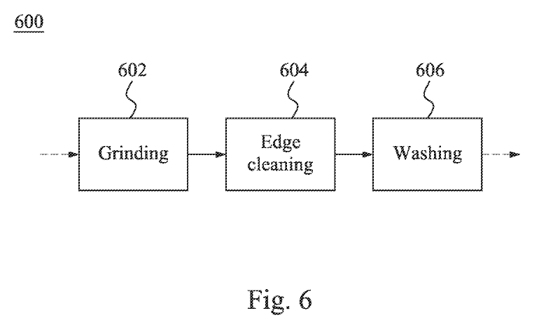

FIG. 6 is a flow diagram of an exemplary manufacturing process 600 for a glass sheet according to some embodiments of the present disclosure. After the glass sheet 10 is formed, the top and bottom surfaces 20, 40 as well as the edges 60 may be ground at step 602 to achieve a desired edge profile and/or surface roughness. In some embodiments, the grinding step 602 may comprise at least one of coarse grinding and fine polishing the edge surfaces of the glass sheet 10.

Conventionally, after the grinding 602 of the glass sheet 10, the process will proceed to step 606 for washing the top and bottom surfaces 20, 40 of the glass sheet 10. Then, the final product of the glass sheet 10 will be shipped away while the particle mist still resides on the edges 60 and migrates to contaminate the surfaces 20, 40 during shipping. Further, it has been known that glass particles that reside on the surfaces of the glass sheet 10 may become chemically bonded to the surfaces 20, 40 in a short period of time. Accordingly, it is desirable to remove the particle mist soon after grinding or polishing steps to prevent the particles from depositing back to the surfaces of the glass sheet or adhering thereto. In FIG. 6, an edge cleaning step 604 may be performed after the glass sheet is ground during step 602. According to FIG. 6, during the edge cleaning step 604, the apparatuses, devices and assemblies 100, 200, 300, 400, 500 described above can be utilized to remove particle mist or other chemical residuals away from the edges 60 of the glass sheet 10. It has been found that the edge cleaning step 604 will advantageously lower the overall particle count and improve the quality of the glass sheet being shipped.

However, the edge cleaning step 604 may be performed simultaneously with or after any other steps during glass manufacture, if so desired. Different sequences of the edge cleaning step are all contemplated by the scope of this disclosure.

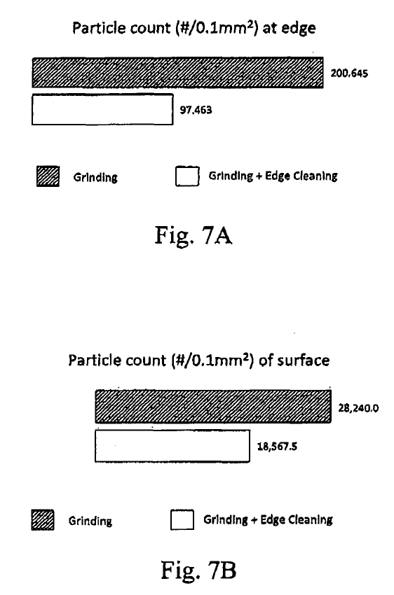

The approach taken in the present disclosure for cleaning edges of the glass sheet advantageously decreases the particle count of the edges as well as the particle count on the top and bottom surfaces. FIGS. 7A and 7B are diagrams showing the measurements after techniques for cleaning edges of a glass sheet described in this disclosure are applied. As shown in FIG. 7A, the particle count at the edges of the glass sheet directly after grinding is normally 200.645 per 0.1 square millimeters in average; whereas the glass sheet undergoing the edge cleaning process will decrease the average particle count at the edges to about 97.463 per 0.1 square millimeters. In other words, the edge cleaning process may reduce about 51% of particles away from the edges of the glass sheet. Further, as shown in FIG. 7B, the particle count of the top surface of the glass sheet directly after grinding is normally 28,240 per 0.1 square millimeters in average; whereas the glass sheet undergoing the edge cleaning process has the average particle count of about 18,567.5 per 0.1 square millimeters. That is, the edge cleaning process also provides 34% reduction of particles away from the top surface of the glass sheet. In view of the above, the edge cleaning process of the present disclosure not only removes the particle mist away from the edges of the glass sheet, but also facilitates cleaning the top and bottom surfaces of the glass sheet. Thus, the apparatus and methods of the present disclosure advantageously improve overall qualities of the glass sheet.

The present disclosure provides techniques for cleaning the glass sheets, so as to reduce the residuals and/or particles from the glass sheets. It should be appreciated that the techniques of the present disclosure may be utilized for removing other objects, such as mixtures or composition of contaminants, from the glass sheets. It will also be apparent to those skilled in the art that the features described with reference to one embodiment can be advantageously applied to other embodiments, and various modifications and variations can be made without departing from the spirit or the scope of the present disclosure.

1. An apparatus for cleaning a glass sheet, comprising:
a brushing device comprising:
a head; and
a plurality of bristles extending from the head, at least one bristle of the plurality of bristles comprising an abrasive material and including a first end attached to the head and a second end opposing the first end;
a motor coupled to the head and configured to rotate the head about a center axis of the head; and
wherein at least a portion of the second end is arranged to contact an edge of the glass sheet during cleaning of the glass sheet.

2. The apparatus of claim 1, wherein the abrasive material comprises Al₂O₃ or SiC or a combination thereof.

3. The apparatus of claim 1, wherein the plurality of bristles extend from the head in parallel with each other and in a direction substantially the same as the center axis of the head.

4. The apparatus of claim 3, wherein the motor is coupled to the head by a shaft and the center axis of the head is parallel with a longitudinal axis of the shaft.

5. The apparatus of claim 3, wherein the motor is coupled to the head by a shaft and the center axis of the head extends at an angle to a longitudinal axis of the shaft.

6. The apparatus of claim 5, wherein the motor is configured to impart a reciprocal motion to the head about the longitudinal axis of the shaft.

7. The apparatus of claim 4, wherein the plurality of bristles extend radially from the head and orthogonal to the center axis.

8. The apparatus of claim 1, wherein the head is detachably coupled to the motor.

9. The apparatus of claim 1, further comprising a coolant delivering device configured to direct a coolant toward the second end of the at least one bristle.

10. The apparatus of claim 1, further comprising a spraying device configured to direct a jet of particle removal fluid toward the edge of the glass sheet.

11. The apparatus of claim 3, wherein the plurality of bristles are arranged in a circular pattern defined by a maximum diameter, and wherein the maximum diameter is greater than a thickness of the glass sheet.

12. The assembly of claim 10, further comprising a baffle positioned adjacent the plurality of bristles.

13. A method for cleaning a glass sheet, comprising:
(a) producing relative motion between an edge of the glass sheet and a brushing device comprising a head, the head comprising a center axis and a plurality of bristles extending from the head, at least one bristle of the plurality of bristles comprising an abrasive material and including a first end attached to the head and a second end opposing the first end;
(b) rotating the head about the center axis; and
(c) contacting the edge of the glass sheet with the plurality of bristles during the rotating.

14. The method of claim 13, wherein during step (c), the at least one bristle is disposed with the second end extending beyond the edge of the glass sheet by a distance of about 1.5-2.5 mm.

15. The method of claim 13, further comprising directing a coolant towards the second end of the at least one bristle.

16. The method of claim 15, wherein step (a) comprises moving the glass sheet in a conveyance direction and wherein the coolant is directed in a direction opposite the conveyance direction.

17. The method of claim 13, further comprising directing a particle removing fluid toward the edge of the glass sheet.

18. The method of claim 13, further comprising imparting a reciprocal motion to the head such that the center axis describes an arc in a plane parallel with a major surface of the glass sheet.

19. The method of claim 13, wherein the center axis is parallel with the edge.

20. The method of claim 13, wherein a rotation speed of the head is in a range from about 3600 revolutions per minute to about 10,000 revolutions per minute.
